(19) United States
(12) Patent Application Publication
(10) Pub. No.: US 2026/0155459 A1
(43) Pub. Date: Jun. 4, 2026

(54) LITHIUM-ION CONDUCTING SEPARATOR MEMBRANE

(71) Applicant: Electrovaya Inc., Mississauga (CA)

(72) Inventors: Rajshekar DasGupta, Oakville (CA); Sankar DasGupta, Mississauga (CA)

(21) Appl. No.: 18/704,747

(22) PCT Filed: Nov. 10, 2022
(86) PCT No.: PCT/IB2022/060855

§ 371 Date: Apr. 25, 2024

Related U.S. Application Data
(60) Provisional application No. 63/277,815, filed on Nov. 10, 2021.

(51) Int. Cl. H01M 10/42; H01M 10/058; H01M 50/403; H01M 50/417; H01M 50/434; H01M 50/446

(52) U.S. Cl. CPC H01M 10/4235; H01M 10/058; H01M 50/403; H01M 50/417; H01M 50/434; H01M 50/446

(57) ABSTRACT

A ceramic polymer separator, an electrochemical cell comprising the ceramic polymer separator, and a method of preparing the same are provided. The ceramic polymer separator is a lithium-ion conducting and electrically insulating membrane for use in an electrochemical cell, including a rechargeable solid-state lithium-ion battery. The membrane is a composite material composed of a non-woven substrate with a ceramic polymer composite material embedded within the pores and on the substrate surface. The novel separator material is combined with electrodes to form a rechargeable solid-state lithium-ion battery.

### CROSS-REFERENCE TO RELATED APPLICATIONS

The present application claims priority to and the benefit of the U.S. Provisional Ser. No. 63/277,815 , filed Nov. 10, 2021, titled “Lithium-Ion Conducting Separator Membrane,” which is hereby incorporated by reference in its entireties as if fully set forth below and for all applicable purposes.

### FIELD OF INVENTION

The disclosure relates to materials and designs for electrochemical energy storage and polymeric materials or polymer ceramic composite materials for lithium-ion conductors and electrode separators for solid-state rechargeable lithium-ion batteries. The disclosure also relates to methods for manufacturing rechargeable solid-state lithium-ion batteries.

### BACKGROUND

Lithium-ion batteries generally include an anode (negative electrode), a cathode (positive electrode), an electrolyte containing a dissociable lithium salt for conducting lithium-ions between the anode and cathode, and a separator that prevents electrical conductivity between the anode and cathode while providing free passage for dissociated lithium-ions. Conventional separators used in lithium-ion batteries are microporous films, while conventional electrolytes used in lithium-ion batteries are volatile flammable solvents, which can cause significant safety concerns as the lithium-ion battery degrades over time. Therefore, there is a need for improved separators that can provide improved performance while simultaneously alleviating safety concerns that plague current lithium-ion battery technologies.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1A illustrates an example embodiment of an electrochemical cell, in accordance with various embodiments.

FIG. 1B illustrates an example embodiment of a bipolar electrochemical cell, in accordance with various embodiments.

FIG. 2 illustrates a method of preparing a separator for an electrochemical cell, in accordance with various embodiments.

FIGS. 3A-3C illustrate a method of preparing an electrochemical cell, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

The technologies disclosed herein relate to a separator with ionic conducting membrane and/or self-healing properties, and a method for manufacturing the same. In accordance with various embodiments, the disclosed separator membrane can be used in lithium-ion batteries that can provide improved performance as well as safety while alleviating the aforementioned short-comings of currently available separators.

As disclosed herein, electrodes, e.g., cathodes and/or anodes, are electroactive energy storage components in a typical lithium-ion battery. While some electrodes are in a form of conductive metal foils, some metal foils may be coated with about 10-100 μm of electroactive composite material. For an anode, the electroactive material can be a lithium foil, lithiated carbon powder (e.g., lithiated graphite or other forms of LiC₆) or a lithium ceramic glass (e.g. Li₄Ti₅O₂ or lithium metal alloys LiM (M=Si, Sn, Zn, In, Ge) bound together with polyvinylidene fluoride (PVDF). For a cathode, the electroactive material can typically be a lithiated metal oxide (e.g., LiCoO₂, LiFePO₄, LiMn₂O₄, LiNiO₂, Li₂FePO₄F, or Li(LiₐNiₓMn_{y}Co_{z})) mixed with a conductive carbon additive (e.g., carbon fiber, carbon black, acetylene black), and bound together with PVDF.

In accordance with various embodiments, a lithium-ion battery can include a separator to prevent electrical conductivity while facilitate conduction of lithium-ions between the anode and cathode. The separator is designed to allow free passage of lithium-ions but block electrical conductivity between the anode and cathode, which would cause a dangerous short circuit. Conventional separators used in lithium-ion batteries are microporous polypropylene films having a thickness of 10-70 microns with a porosity of 20-80%, for example, described by Zhang, Z. et. al. in U.S. Pat. No. 6,432,586B 1, granted on Aug. 13, 2002. The inclusion of a separator unavoidably increases the ionic resistance of the battery, as described by Liu, J. et. al. in the Journal of Solid-state Electrochemistry 23, 277 in 2019. The separator must be thick enough to impart sufficient mechanical strength to prevent short circuiting, but thin enough to retain sufficient ionic conductivity. The lithium-ion conductivity and lithium inventory of the electrolyte impact the maximum current that a battery can achieve. Highly porous separators maximize lithium inventory and, as much as possible, help prevent the loss of ionic conductivity that accompanies the inclusion of a separator. This comes with a trade-off, as more porous membranes will be weaker and provide less protection against short circuiting. Separator components can also increase the cost of materials and complexity of the manufacturing process for lithium-ion batteries, with the separator accounting for up to 10% of the total cost of manufacturing a lithium-ion battery.

In various embodiments, an electrolyte may contain a dissociable lithium salt having a lithium cation and an inorganic anion (e.g., lithium hexafluorophosphate, lithium tetrafluoroborate, lithium triflate, lithium bistriflimide, or lithium 2-Trifluoromethyl-4,5-dicyanoimidazolide (LiTDI), Lithium bis(trifluoromethanesulfonyl)imide (LiTFSI) or Lithium bis(fluorosulfonyl)imido (LiFSI)), or some mixture thereof dissolved in an organic liquid or polymer gel (e.g., ethylene carbonate, propylene carbonate, dimethyl carbonate, ethyl-methyl carbonate, fluorinated ethylene carbonate, polyethylene oxide, or some mixture thereof). The electrolyte must be able to conduct lithium-ions between the anode and cathode, and can either be a solid, liquid, or mixture of both.

In various embodiments, liquid electrolytes may include volatile and flammable solvents, causing significant safety concerns as the lithium battery degrades over time. Solid polymer electrolytes were developed to counteract this problem, as polymer electrolytes are less volatile and less flammable. Since polymer electrolytes are also electrically insulating, the material strength of the polymer determines whether or not a mechanically robust separator membrane is also needed or if the polymer electrolyte can fill both roles. Polymer electrolytes must be flexible and polar to conduct ions efficiently, and classes of ion conducting polymers include polysiloxanes (as described by Buisine et. al. in worldwide patent no. WO20169955A1, filed on Apr. 20, 2016), polycarbonates (as described by Smith et. al. in U.S. Pat. No. 7,354,531B2, granted on Apr. 8, 2008), polyethylene oxides and other polyglycols (as described by Vissers, et. al. in U.S. Pat. No. 7,226,702B2, granted on Jun. 5, 2006), or acrylates (as described by Nishi et. al. in United States patent no. U.S. Pat. No. 5,609,795A, granted on Mar. 11, 1997). Polymer electrolytes can also be mixtures of these polymers/copolymers in varying amounts with each other or other polymers, like PVDF, to provide structural support. Soft and flexible polymers have higher ionic conductivities, but their poor mechanical strength means a large thickness and an electrically insulating separator prevents short circuiting, with many of the previous patents having a thickness of greater than 20 microns. Soft polymers combined with a mechanically robust separator to form a composite polymer/electrolyte have been described, for example by Das Gupta et. al. in Canadian U.S. Pat. No. 2,321,431, granted on Dec. 14, 2001. In general, polymer electrolytes include thicker electrolyte layers and additional polymer separator membranes, increasing the ionic conductivity of the battery. Because of this, polymer electrolyte systems need to be operated at temperatures above typical battery operation conditions (−20 to 40° C.) as described in the patents above, by M. Zafar et. al. in Canadian patent no. CA2382118A1, filed on Aug. 21, 2000, and by Kelly et al. in J. Power Sources, 14, 13 in 1985. Solid ceramic ion conductors are mechanically strong enough to reliably electrically separate the electrodes without an extra separator component, but typically at the cost of low ion conductivity. Solid-state ceramic electrolytes contain a lithium conductivity of 10⁻⁶-10⁻³ S/cm between 100-150° C., as described by Waschman et. al. in U.S. patent no. 20140287305A1, granted on Apr. 14, 2020. Solid ceramic electrolytes can have a lower conductivity than polymer electrolytes at low temperatures, and the increase in resistance of the system reduces the overall battery performance. Taking the trade-off between polymer conductivity and mechanical strength into account when determining how thick or thin a polymer needs to be is critical when designing electrolyte/separators. As such, it is apparent that a polymer of moderate strength and moderate ion conductivity that strongly adheres to an electrode may be useful in allowing polymer electrolytes to provide good electronic insulation between electrodes in a thin enough layer to retain good ion conductivity. This would allow a solid-state polymer battery to operate safely with good power output characteristics at room temperature.

For solid/ceramic electrolytes, for instance, significant problems also arise due to the brittle nature of ceramics when operating in environments with vibrations and other shock forces. Vibrations and shock forces present during typical use of an EV cause ceramic electrolytes to crack and fracture. This decreases the ionic conductivity of the electrolyte, reducing battery performance for all anode/cathode combinations. An additional advantage of our soft-polymer electrolyte is that it is soft and flexible and does not fracture when subjected to the vibrations that occur during normal operation of electric vehicles.

In accordance with various embodiments, a novel separator disclosed herein is provided for use in an electrochemical cell or a rechargeable solid-state lithium-ion battery. In accordance with various embodiments and implementations, the separator for a rechargeable solid-state lithium-ion battery is described. The separator includes a membrane (or a polymer membrane) embedded with a ceramic polymer composite. The ceramic polymer composite material is lithium-ion conducting. In various embodiments, the polymer component includes a microporous crosslinked polymer containing a dissociable lithium salt that can function as an ion conducting component. The separator material can also be impregnated with a plasticizing organic carbonate liquid containing a dissociable lithium salt of either the same or a different composition as the dissociable lithium salt present in the material to increase lithium inventory in the electrolyte and increase lithium-ion conductivity.

The composite ion conducting separator material may be obtained by coating the porous polymer substrate with a solution containing a highly reducing chemical/electrochemical environment with contents containing ion conducting ceramic materials. These ceramic materials may include but not limited to lithium conducting sulphides, e.g., Li₂S, P₂S₅; lithium phosphates, e.g., Li₃P; or lithium oxides, e.g., lithium lanthanum titanium oxide, lithium lanthanum zirconium oxide, or the like. The solution may contain contents, at least in part, a carbonate based organic liquid and a LiTDI-based dissociable lithium salt. LiTDI is well known as an electrolyte that is water stable and can allow for long life lithium-ion batteries when used in concentrations of between 1 ppm and 10 ppm, as described by Bonnet et. al. in US patent no. 20160380309A1, published on Dec. 29, 2016. The process by which LiTDI initiates a polymerization reaction of a carbonate solvent has been described by Abraham et. al. in the Journal of Physical Chemistry C, 50, 28463, in 2016. The use at least in part of LiTDI (between 0.1M and 1.5M) as the dissociable lithium salt is described.

In various embodiments, the reaction of LiTDI in a highly reducing environment produces 2 equivalents of lithium fluoride and one equivalent of a lithium 2-fluoromethylene-4,5-dicyanoimidazolide anion (LiTDI⁻). The LiTDI⁻ anion initiates an anionic ring opening polymerization of organic carbonate liquids to form a polycarbonate type polymer with a final composition that depends on the carbonate solvent mixture (monomers) used. In this disclosure, a combination of solvents including ethylene carbonate, dimethyl carbonate, ethyl-methyl carbonate, propylene carbonate, and fluorinated ethylene carbonate, in combination with a lithium based reducing agent like lithium metal or lithium aminoborohydride (LAB) reagents (Lithium pyrrolidinoborohydride Lithium dimethylaminoborohydride-Lithium morpholinoborohydride) be used in varying amounts to form polymerized compounds. Different ratios of these carbonate liquids, LiTDI and reducing agents will impart different microstructures, crosslinking amounts, and ionic conductivities. The reaction between the reducing agent and the organic solvents with LiTDIs can result in forming fine particles, which are embedded in the polymer substrate pores when used in a coating process.

For lithium metal anodes, the formation of lithium dendrites has been shown to be a significant enough safety concern to make them not commercially viable in rechargeable batteries. Single crystal solid electrolytes are sought after as solid electrolytes as they are shown to prevent lithium dendrites from forming. Unfortunately, as fractures form in the electrolyte crystal due to vibrations and shock forces due to their brittle nature, dendrites can begin to form within the cracks, and the solid-state battery becomes unsafe for long term use (described by Guo, X et. al. in Electrochemical Energy Reviews, published on Jul. 27, 2020 and Y.-B. He et. al. in Frontiers in Materials, published on Mar. 25, 2020). While lithium dendrites are generally able to form in solid polymer electrolytes no matter their elastic modulus (described by Zhang, Q. et. al. in ACS Energy Letters, published on Feb. 7, 2020).

In accordance with various embodiments, the separator is a ceramic polymer composite separator with ion conducting properties. The separator can provide a variety of protections, including for example, but not limited to, preventing lithium dendrites from penetrating through the separator. These protections can be in a form of physical barriers provided by the ceramic and polymeric materials, in addition to a system where lithium metal is passivated by polymeric SEI materials that are also embedded in the separator structure. These materials provide a “self healing” capability. When a lithium metal dendrite comes in contact with these materials (e.g., particles), the dendrite would experience the aforementioned reaction between lithium metal, LiTDI, and carbonate solvents to form a passivating polymer layer on the lithium-based dendrite.

In various embodiments, the separator is placed between an anode and a cathode to form a rechargeable lithium-ion battery. The disclosure herein relates to a method for manufacturing a separator with ionic conducting and self-healing properties. The following describes one or more methods for producing the separator membrane in accordance with steps a)-d) discussed below.

Step a) Create a slurry solution containing organic carbonates (e.g., ethylene carbonate, dimethyl carbonate, ethyl-methyl carbonate, propylene carbonate, fluorinated ethylene carbonate, or some mixture thereof) containing lithium TDI in a concentration between 0.1 M and 1.7 M. The slurry also contains small concentrations of a lithium based reducing agent which can be lithium metal based in the form of powders, flakes or stabilized powders or lithium aminoborohydride (LAB) reagents (e.g., lithium pyrrolidinoborohydride, lithium dimethylaminoborohydride, lithium morpholinoborohydride). The lithium based reducing agent is mixed with sufficient time and temperature such that they reduce the LiTDI to form the aforementioned polymeric material. The entirety of the lithium based reducing agent or a sufficient plurality is fully consumed or coated with through the reduction reaction.

Step b) Following complete consumption of the lithium based reducing agent through the reducing reaction described above, lithium-ion conducting ceramic materials including but not limited to lithium conducting sulphides, e.g., Li₂S, P₂S₅; lithium phosphates, e.g., Li₃P; or lithium oxides, e.g., lithium lanthanum titanium oxide, lithium lanthanum zirconium oxide, or the like, are added into the solution. These materials have a particle size ranging between 0.5 microns and 20 microns.

Step c) A porous polymer, ceramic or cellulose based substrate (including, for example, but not limited to, PET, PO, PE, PP, boron nitride fibers or non-woven cellulose-based materials) or a base material as described with a ceramic coating with thickness between 5 and 40 microns and porosity of 20-80% are coated with the solution described in a) and b) above. The resultant materials have both ceramic and polymeric materials embedded in the pores resulting in a ceramic polymer composite material with lithium-ion conducting capability. This coating can also be made on a single side of the substrate.

Step d) Drying or partial drying of the coated separator removes any excess solution by applying a temperature or a vacuum, or calendaring.

In accordance with various embodiments, a rechargeable lithium-ion battery can be assembled having a lithium metal anode laminated on a copper current collector and the novel separator material as described herein with a NMC cathode laminated on an aluminum current collector. The separator can have a thickness between 5 microns and 40 microns, and can be produced using the method described as disclosed herein.

In various embodiments, the anode can be lithium metal, onto which the separator is deposited or bare/treated copper current collectors. Alternatively, other anode materials, such as, for example, but not limited to, lithiated graphite, other forms of LiC₆, or a lithium ceramic glass (e.g., Li₄Ti₅O₂, Si(Li_{4,4}Si), or lithium metal alloys LiM (M=Si, Sn, Zn, In, Ge) bound together with PVDF can be used. The anode coated with a solid electrolyte/separator was then combined with a cathode consisting of 5 % conductive carbon additive, 5% PVDF binder, and 90 % Li(Ni₁Mn₁Co₁O₂) having a particle size of 20 microns, attached to a metal foil current collector. Other cathodes can reasonably be used, e.g., LiCoO₂, LiFePO₄, LiMn₂O₄, LiNiO₂, Li₂FePO₄F, or Li(LiₐNiₓMn_{y}Co_{z}) or lithium containing metal oxides of various compositions.

The anode/cathode polymer electrolyte/separator assembly can be sealed inside a 2032 coin cell under an inert atmosphere for analysis. The cell can have an active surface area of 250 mm². During the analysis, the lithium-ion battery can be charged to 4.2 V and discharged to 3.0 V at a current density of between 300-400 mAh/g. When a coin cell containing the electrolyte/separator adhered to the anode is charged/discharged at 0.33 mA, a voltage drop of between 25 mV and 125 mV is observed, indicating an internal resistance of 190-950 ohm-cm at room temperature. Since the anode and cathode contain conductive carbons, they generally have negligible resistances (e.g., less than 10 ohm-cm), the measured resistance can be almost entirely attributed to the electrolyte/separator.

In various embodiments, the lithium-ion battery can safely operate solely with the polymer electrolyte/separator and without the need for a separate separator component. The lithium salt in lithium-ion batteries described herein can include LiTDI. In addition, other lithium compounds, such as lithium perchlorate, lithium triflate, lithium triflimide, lithium hexafluorophosphate, lithium tetrafluoroborate, or other lithium salts soluble in organic substances can also include in varying amounts. Some of the advantages of the disclosed electrolyte system imbue innate flexibility to the polymer electrolyte/separator/SEI that prevents fracture during operation in electric vehicles, and also provide self-healing properties to the SEI, effectively preventing dendrite growth that commonly plagues polymer electrolytes. Furthermore, standard lithium-ion cell assembly methods can be utilized. Although the present disclosure has been described with reference to the preferred embodiments, it is to be understood that modifications and variations may be resorted to without departing from the spirit and scope of the invention, as those skilled in the art will readily understand. Such modification and variations are considered to be within the purview and scope of the invention and the appended claims.

In various embodiments, a lithium-ion conducting ceramic polymer composite separator membrane for a rechargeable battery with a lithium metal anode or bare copper (anode free) current collector, comprising a lithium-ion conducting and electrically insulating membrane that is applied between a positive and negative electrode. The separator membrane is a composite material composed of a polymer, ceramic or cellulose based substrate with a ceramic polymer composite material that is ionically conducting and containing SEI forming properties embedded within the pores and on the substrate surface. The separator is then combined with the opposing electrodes to form a rechargeable solid-state lithium-ion battery or lithium metal rechargeable battery.

In various embodiments, a composite separator membrane for a rechargeable solid-state lithium-ion battery, wherein the substrate is composed of one of or a combination of PET, PP, PE, PO, boron nitride or cellulose based materials with a porosity of between 20% and 80%. The thickness of the uncoated substrate can be between 5 microns and 40 microns.

In various embodiments, a composite separator membrane for a rechargeable solid-state lithium-ion battery, wherein the substrate also contains an inert ceramic coating of Alumina (Al₂O₃) or Boehmite AlO(OH). The thickness of the uncoated substrate can be between 5 microns and 40 microns.

In various embodiments, a composite separator membrane for a rechargeable solid-state lithium-ion battery, wherein any of the substrates described above can be coated in a slurry comprising of organic carbonates (e.g., ethylene carbonate, dimethyl carbonate, ethyl-methyl carbonate, propylene carbonate, fluorinated ethylene carbonate, or some mixture thereof) containing lithium TDI in a concentration between 0.1 M and 1.7 M. The slurry also contains concentrations of a lithium based reducing agent which can be lithium metal based in the form of powders, flakes or stabilized powders or lithium aminoborohydride (LAB) reagents (Lithium pyrrolidinoborohydride Lithium dimethylaminoborohydride-Lithium morpholinoborohydride) and can be mixed with sufficient time and temperature such that the lithium based reducing agent electrochemically reduce the LiTDI to form lithium fluoride and one equivalent of a lithium 2-fluoromethylene-4,5-dicyanoimidazolide anion (LiTDI⁻). The LiTDI⁻ anion initiates an anionic ring opening polymerization of organic carbonate liquids to form a polycarbonate type polymer. The entirety of the lithium based reducing agent or a sufficient plurality can be fully consumed through the reduction reaction prior to the separator coating process.

In various embodiments, a composite separator membrane for a rechargeable solid-state lithium-ion battery, wherein a material is coated in a slurry that contains lithium-ion conducting ceramic materials, including, but not limited to, lithium conducting sulphides, e.g., Li₂S, P₂S₅; lithium phosphates, e.g., Li₃P; or lithium oxides, e.g., lithium lanthanum titanium oxide, lithium lanthanum zirconium oxide, or the like, are added into the solution. These materials have a particle size ranging between 0.5 microns and 20 microns.

In various embodiments, a composite separator membrane for a rechargeable solid-state lithium-ion battery, wherein a polymer is a polycarbonate, or carbonate containing polymer with a monomer composition corresponding to the composition of the carbonate containing liquid.

In various embodiments, a composite separator membrane for a rechargeable solid-state lithium-ion battery, wherein a cathode electrode is also coated with the same slurry as described above.

In various embodiments, a composite separator membrane for a rechargeable solid-state lithium-ion battery, wherein the cathode electrode is also coated with the same slurry described above.

In various embodiments, a composite separator membrane for a rechargeable solid-state lithium-ion battery, wherein the anode electrode is also coated with the same slurry described above.

In various embodiments, a composite separator membrane for a rechargeable solid-state lithium-ion battery, wherein the anode electrode is also coated with the same slurry described above.

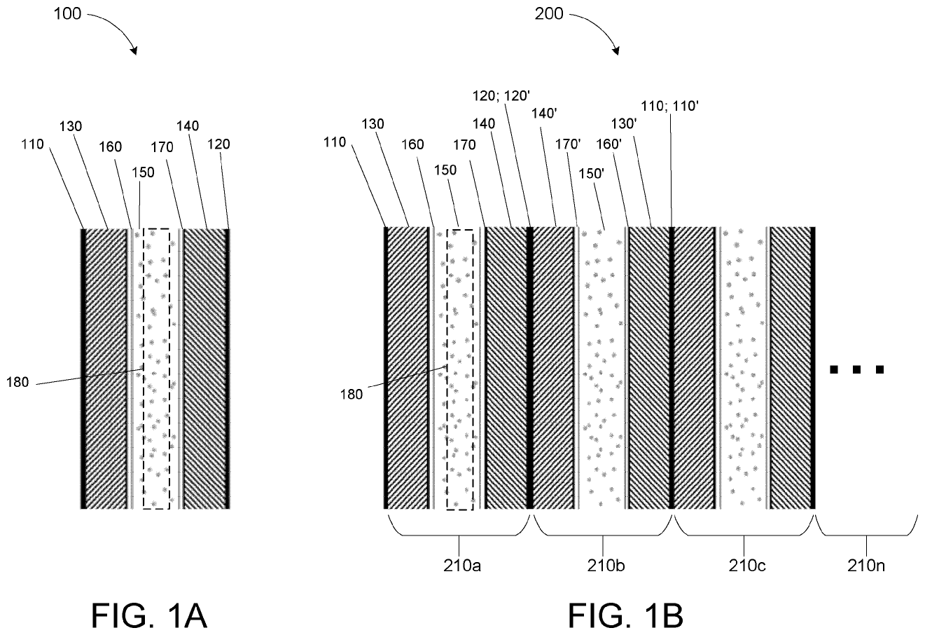

In accordance with various embodiments, materials, designs, and methods disclosed herein, energy storage devices and methods of preparing the same are further described with respect to FIGS. 1A, 1B, 2, 3A, 3B, and 3C.

FIG. 1A illustrates an example embodiment of an electrochemical cell 100, in accordance with various embodiments. In accordance with various embodiments, the electrochemical cell 100 can include a battery, a lithium battery, a lithium-ion battery, a solid-state lithium battery, a solid-state lithium-ion battery, a lithium metal battery, a lithium polymer battery, or any other devices that utilize electrochemistry of chemical materials.

As illustrated in FIG. 1A, the electrochemical cell 100 includes a first current collector 110 and a second current collector 120. The first current collector 110 is for a first electrode 130 and the second current collector 120 is for a second electrode 140. In various embodiments, the first electrode 130 is an anode and the second electrode 140 is a cathode. In various embodiments, the first electrode 130 is a cathode and the second electrode 140 is an anode.

In various embodiments, the first electrode 130 can include a lithium metal, lithium foil, a treated copper foil, treated copper foil a graphite, a lithiated graphite, LiC₆, a lithium ceramic glass, Li₄Ti₅Oi₂, Li_{4,4}Si, or Li_{4,4}Ge bound together with polyvinylidene fluoride (PVDF).

In various embodiments, the second electrode 140 can include a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

As illustrated in FIG. 1A, a layer 150 is disposed between the first electrode 130 and the second electrode 140. In various embodiments, the layer 150 can be referred to as separator 150. In various embodiments, the layer/separator 150 can be a combined polymer electrolyte and separator described herein. In various embodiments, the separator 150 can be or can include a membrane embedded with a ceramic polymer composite. The ceramic polymer composite can include a microporous crosslinked polymer containing a dissociable lithium salt that functions as an ion-conducting component of the membrane. The membrane can include embedded pores within the membrane.

In various embodiments, the ceramic polymer composite of the separator 150 can be electrically insulating, ionically conducting, and capable of growing solid electrolyte interphase (SEI) within the membrane or within embedded pores of the membrane due to a presence of lithium 2-fluoromethylene-4,5-dicyanoimidazolide anion (LiTDI⁻). In various embodiments, the membrane of the separator 150 can include one or more of PET, PP, PE, PO, boron nitride or cellulose-based materials. In various embodiments, the ceramic polymer composite can include one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

In various embodiments, the membrane can include an inert ceramic coating of Alumina (Al₂O₃) or Boehmite AIO(OH). In various embodiments, a porosity of the membrane can be between 20% and 80%. In various embodiments, the membrane can have a thickness between 5 microns and 40 microns.

In various embodiments, the membrane of the separator 150 can also include a plasticizing organic carbonate liquid containing a dissociable lithium salt. In various embodiments, the membrane can include a composition containing the dissociable lithium salt, the composition being different from the plasticizing organic carbonate liquid. The membrane can include a polycarbonate or a carbonate containing a polymer with a monomer composition corresponding to a composition of carbonate containing liquid from a list of organic carbonates, ethylene carbonate, dimethyl carbonate, ethyl-methyl carbonate, propylene carbonate, fluorinated ethylene carbonate, or a mixture thereof.

In various embodiments, the separator 150 as disclosed herein can be implemented in a solid-state lithium-ion battery and/or a lithium metal rechargeable battery, or any form of the electrochemical cell 100.

In various embodiments, the layer/separator 150 can have a thickness ranging between about 0.1 microns and about 50 microns, between about 0.2 microns and about 40 microns, between about 0.3 microns and about 20 microns, between about 0.4 microns and about 10 microns, or between about 0.1 microns and about 10 microns, inclusive of any thickness ranges therebetween.

In various embodiments, the layer/separator 150 can contain a dissociable lithium salt concentration range of about 0.1 M to about 1.7 M, about 0.2 M to about 1.0 M, about 0.3 M to about 0.8 M, about 0.4 M to about 0.5 M, about 0.1 M to about 1.0 M, or about 0.1 M to about 0.5 M, inclusive of any concentration ranges therebetween.

In various embodiments, the layer/separator 150 can be swollen with a mount of about 1 ppm to about 50 wt. % of the layer of an organic carbonate-based liquid as disclosed herein.

As further illustrated in FIG. 1A, the electrochemical cell 100 also includes a first interface 160 that is formed between the first electrode 130 and the layer/separator 150 and a second interface 170 that is formed between the second electrode 140 and the layer/separator 150. The first interface 160 and the second interface 170 are the interfaces between the solid polymer electrolyte/separator and the anode or cathode of the electrochemical cell 100.

In various embodiments, the layer/separator 150 can include a portion of solvent swollen within the layer, wherein, during operation, the portion of swollen solvent reacts with a growing dendrite to form polymers on the dendrite. In various embodiments, the layer/separator 150 can include a fluorinated ethylene carbonate is used as a crosslinking agent, for example, for the solid polymer electrolyte. In various embodiments, the layer/separator 150 can include the solid polymer electrolyte that is polymerized to a surface of the first electrode 130 or second electrode 140. In various embodiments, the layer/separator 150 includes passivating polymer layer that is microporous and comprises self-healing properties as a result of a mixture of dissociable lithium salt, carbonate solvent mixture, and lithium metal surface. In various embodiments, the passivating polymer layer is adherent to the first and/or second electrode and prevents dendrite growth due to its self-healing properties.

In various embodiments, the layer/separator 150 includes a solid polymer electrolyte that comprises a polymer ceramic composite material or one or more ion conducting ceramic or inorganic materials. In various embodiments, the layer/separator 150 can include one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

In various embodiments, the layer/separator 150 includes a solid polymer electrolyte that is capable of growing a passivating polymer layer at an interface (e.g., first interface 160) between the first electrode 130 and the solid polymer electrolyte of the layer/separator 150. In various embodiments, the layer/separator 150 includes a solid polymer electrolyte that is capable of growing a passivating polymer layer at an interface (e.g., the second interface 170) between the second electrode 140 and the solid polymer electrolyte of the layer 150. In various embodiments, the passivating polymer layer is adherent to the first and/or second electrode 130/140 and prevents dendrite growth due to its self-healing properties.

In various embodiments, the layer/separator 150 includes a solid polymer electrolyte that includes a polymer ceramic composite material, one or more ion conducting ceramic or inorganic materials, or one or more material from a list of materials comprising a lithium conducting sulphide, Li₂S, P₂S₅, a lithium phosphate, Li₃P, a lithium oxide, lithium lanthanum titanium oxide, and lithium lanthanum zirconium oxide.

In various embodiments, the layer/separator 150 includes at least a portion of the separator that is porous. In various embodiments, the porous portion can be swollen with an organic liquid and a dissociable lithium salt. In various embodiments, the dissociable lithium salt dissolved in an organic liquid can include one or more of lithium 2-Trifluoromethyl-4,5-Dicyanoimidazolide, lithium hexafluorophosphate, lithium triflate, lithium triflimide, lithium perchlorate, lithium tetrafluoroborate, or lithium bistriflimide.

In various embodiments, the layer/separator 150 includes a microporous polymer that is deposited or adhered to at least one face of at least one electrode by electrodeposition, chemical reduction, electrochemical reduction, or immersion of the electrode in a corresponding solution containing organic carbonates and a dissociable lithium salt. In various embodiments, the layer/separator 150 includes a microporous polymer that possesses self-healing properties as a result of the specific mixture of dissociable lithium salt, carbonate solvent mixture, and lithium metal surface. In various embodiments, the layer/separator 150 includes a microporous polymer that prevents dendrite growth due to its self-healing properties. In various embodiments, the layer layer/separator includes a microporous polymer that resists fracture and cracking as a result of vibrational and shock forces typically seen in battery use in electric vehicles.

In various embodiments, the layer/separator 150 includes a structural support 180. In various embodiments, the structural support 180 can include an inert polymer mesh. In various embodiments, the inert polymer mesh can include polyethylene, polyethylene terephthalate, PVDF, a cellulose derivative, polyimide, or polyether-ether-ketone.

In various embodiments, the first current collector 110 (e.g., anode) can include a metal mesh made of copper, aluminum, or stainless steel. In various embodiments, the first current collector 110 has a thickness of about 5 microns to about 200 microns. In various embodiments, the first current collector 110 (e.g., anode) includes a porous mesh comprising pores within the anode current collector and wherein a porosity of the anode current collector ranges from 25% to 75%. In various embodiments, the first current collector 110 (e.g., anode) includes pores that are filled or substantially filled with lithium when the battery is charged. In various embodiments, the first current collector 110 (e.g., anode) includes pores that lector are devoid or substantially devoid of lithium when the battery is discharged. In various embodiments, the first current collector 110 (e.g., anode) includes a metal mesh filled with lithium metal does not change volume as the battery charges or discharges.

In various embodiments, an electrochemical cell, such as electrochemical cell 100, can include the ceramic composite separator, such as the layer/separator 150, as disclosed herein. The cell can also include a first electrode, such as first electrode 130 and a second electrode, such as second electrode 140. In various embodiments, the first electrode can be a cathode or an anode. In various embodiments, the second electrode can be a cathode or an anode. In various embodiments of the cell, the ceramic composite separator, such as layer/separator 150, can include a membrane embedded with a ceramic polymer composite. In various embodiments, the ceramic polymer composite can include a microporous crosslinked polymer containing a dissociable lithium salt that functions as an ion-conducting component of the membrane. In various embodiments, the ceramic composite separator can include embedded pores within the membrane. In various embodiments, the ceramic polymer composite is electrically insulating, ionically conducting, and capable of growing solid electrolyte interphase (SEI) within the membrane or within embedded pores of the membrane due to the presence of lithium 2-fluoromethylene-4,5-dicyanoimidazolide anion (LiTDI⁻). In various embodiments, the membrane can include one or more of PET, PP, PE, PO, boron nitride or cellulose-based materials. In various embodiments, the ceramic polymer composite can include one or more material from a list comprising a lithium conducting sulphide, Li₂S, P₂S₅, a lithium phosphate, Li₃P, a lithium oxide, lithium lanthanum titanium oxide, and lithium lanthanum zirconium oxide. In various embodiments, the membrane can include an inert ceramic coating of Alumina (Al₂O₃) or Boehmite AlO(OH).

In various embodiments of the cell, a porosity of the membrane can be between 20% and 80%. In various embodiments, the membrane has a thickness between 5 microns and 40 microns. In various embodiments, the membrane can include a plasticizing organic carbonate liquid containing a dissociable lithium salt. In various embodiments, the membrane may include a composition containing the dissociable lithium salt, the composition that is different from the plasticizing organic carbonate liquid. In various embodiments, the membrane can include a polycarbonate or a carbonate containing a polymer with a monomer composition corresponding to a composition of carbonate containing liquid from a list of organic carbonates, ethylene carbonate, dimethyl carbonate, ethyl-methyl carbonate, propylene carbonate, fluorinated ethylene carbonate, or a mixture thereof.

In various embodiments of the cell, the first electrode can include a lithium metal, lithium foil, a graphite, a lithiated graphite, LiC₆, a lithium ceramic glass, Li₄Ti₅O₂, Li_{4,4}Si, or lithium metal alloys LiM, wherein M is Si, Sn, Zn, In, and/or Ge, bound together with polyvinylidene fluoride (PVDF). In various embodiments, the first electrode can include a coating having one or more materials from a list of organic carbonates, ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI), lithium bis(trifluoromethanesulfonyl)imide (LiTFSI) or lithium bis(fluorosulfonyl)imido (LiFSI). In various embodiments, the first electrode can include a plurality of lithium metal particles.

In various embodiments of the cell, the second electrode can incluide a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF. In various embodiments, the second electrode can incluide a coating having one or more materials from a list of organic carbonates, ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI). In various embodiments, the second electrode can include a plurality of lithium metal particles.

In various embodiments of the cell, the ceramic composite separator can include self-healing properties as a result of a specific mixture of a dissociable lithium salt, a carbonate solvent mixture, and lithium metal surface. In various embodiments, the ceramic composite separator can prevent dendrite growth due to its self-healing properties. In various embodiments, the ceramic composite separator can resist fracture and cracking as a result of vibrational and shock forces typically seen in battery use in electric vehicles.

FIG. 1B illustrates an example embodiment of a bipolar electrochemical cell 200, in accordance with various embodiments. As illustrated in FIG. 1B, the bipolar electrochemical cell 200 can be built by stacking two or more of the electrochemical cell 100 of FIG. 1A back to back to one another. In accordance with various embodiments, since the bipolar electrochemical cell 200 can be built by stacking two or more of the electrochemical cell 100 in a bipolar cell arrangement, each and every component of the bipolar electrochemical cell 200 can include respective components of the electrochemical cell 100, which are described respect to FIG. 1A, and thus, the various components of the bipolar electrochemical cell 200 are identical, similar or substantially similar to those of the electrochemical cell 100 and will not be described in further detail.

As illustrated in FIG. 1B, the bipolar electrochemical cell 200 can include a first cell 210a, a second cell 210b, a third cell 210c, and so on and so forth, to 210n. Each of the cells, for example, 210a, 210b, . . . , 210n, can include a first current collector 110 and a second current collector 120, a first electrode 130 and a second electrode 140, a layer/separator 150, a first interface 160 that is formed between the first electrode 130 and the layer/separator 150, and a second interface 170 that is formed between the second electrode 140 and the layer 150. The bipolar electrochemical cell 200 illustrated in FIG. 1B includes, for example, the first cell 210a and the second cell 210b that are disposed back to back, whereby the second current collector 120 serves as a common current collector, for example, the second current collector 120 of the first cell 210a and the second current collector 120′ of the adjacent second cell 210b. As illustrated, the second cell 210b includes a first electrode 130′ and a second electrode 140′, a layer 150′, a first interface 160′ that is formed between the first electrode 130′ and the layer/separator 150′, and a second interface 170′ that is formed between the second electrode 140′ and the layer/separator 150′. Similarly, the third cell 210b can include similar layers of materials but may be in the same reverse order as in the first cell 210a but reverse order as in the second cell 210c. Accordingly, the common current collectors 110, 110′, 120, and 120′ can form respective negative and positive terminals of the bipolar battery stack of the bipolar electrochemical cell 200 of FIG. 1B.

In various embodiments, the bipolar electrochemical cell 200 can be constructed into a high voltage bipolar lithium-ion battery having the combined layers and components as disclosed herein with respect to FIGS. 1A and 1B. In various embodiments, the voltage of this battery can be varied by changing the number of cells in the stack.

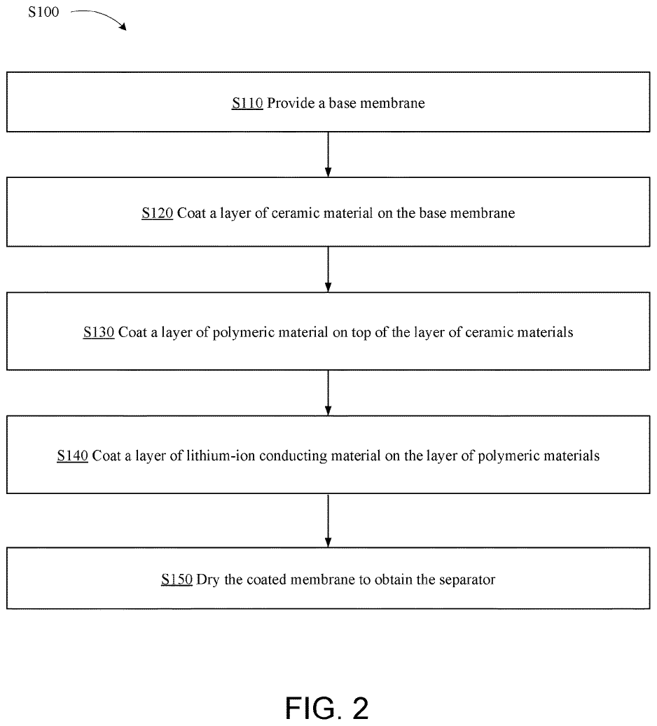

FIG. 2 illustrates a method S100 of preparing a separator for an electrochemical cell, in accordance with various embodiments. The prepared separator based on the disclosed method can be used in an electrochemical cell. The method S100 includes, at step S110, providing a base membrane; at step S120, coating a layer of ceramic material on the base membrane; at step S130, coating a layer of polymeric material on top of the layer of ceramic materials; and at step S140, coating a layer of lithium-ion conducting material on the layer of polymeric materials; and at step S150, drying the coated membrane to obtain the separator.

In various embodiments of method S100, the base membrane can include a porous polymer or a cellulose substrate. In various embodiments, the base membrane can include one of PET, PO, PE, PP, boron nitride fibers or non-woven cellulose-based materials. In various embodiments, the base membrane can have a porosity between 20% and 80%. In various embodiments, the layer of ceramic material can have a thickness between 5 microns and 40 microns. In various embodiments, the polymeric material can include one or more of ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI). In various embodiments, the polymeric material can include a plurality of lithium metal particles.

In various embodiments of method S100, the lithium-ion conducting material can include one or more material from a list comprising a lithium conducting sulphide, Li₂S, P₂S₅, a lithium phosphate, Li₃P, a lithium oxide, lithium lanthanum titanium oxide, and lithium lanthanum zirconium oxide. In various embodiments, the lithium-ion conducting material can include particles with a particle size ranging between 0.5 microns and 20 microns.

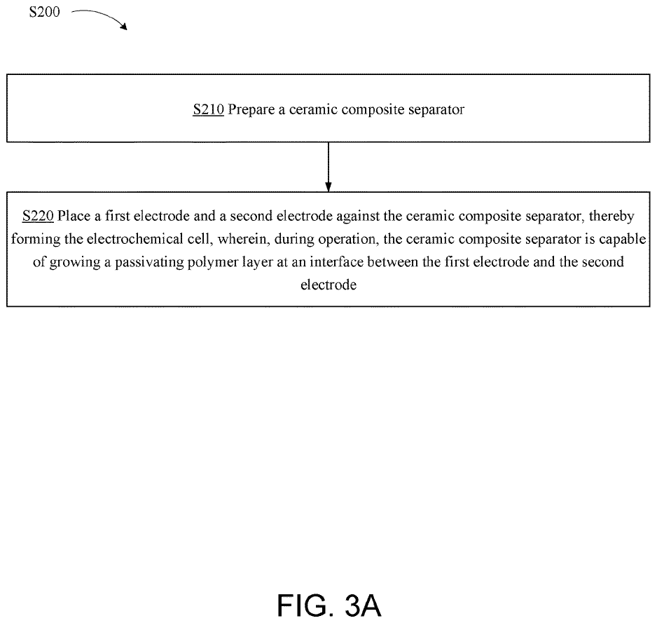

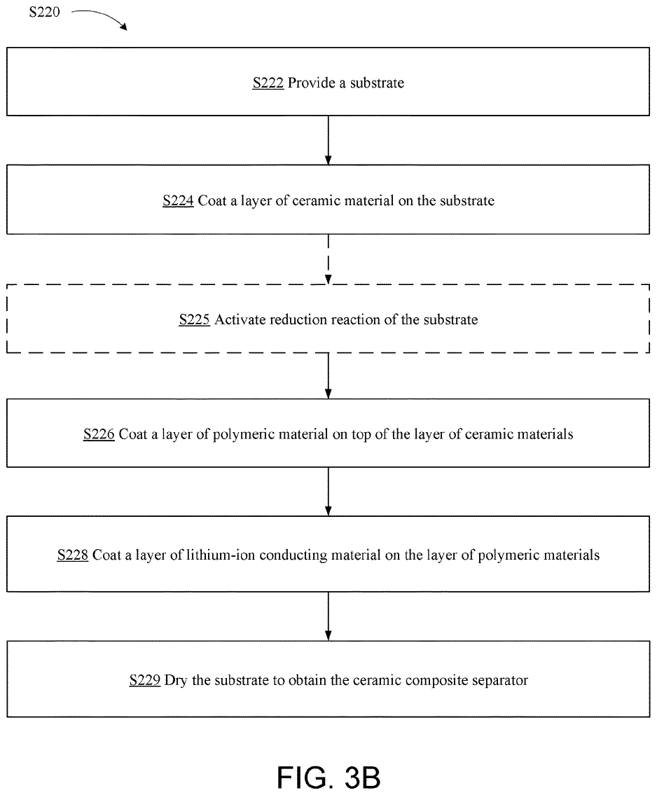

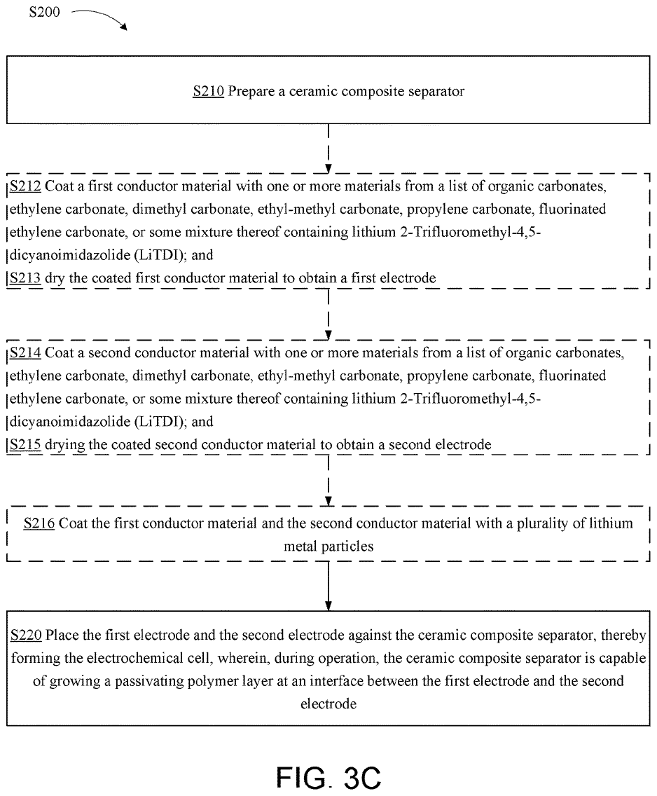

FIGS. 3A-3C illustrate a method S200 of preparing an electrochemical cell, in accordance with various embodiments. As illustrated in FIG. 3A, method S200 includes, at step S210, preparing a ceramic composite separator; and at step S220, placing a first electrode and a second electrode against the ceramic composite separator, thereby forming the electrochemical cell. In various embodiments, during operation, the ceramic composite separator prepared using method S200 is capable of growing a passivating polymer layer at an interface between the first electrode and the second electrode.

As illustrated in FIG. 3B, in accordance with various embodiments of method S200, the preparation of the ceramic composite separator at step S220 may include providing a substrate at step S222, coating a layer of ceramic material on the substrate at step S224, coating a layer of polymeric material on top of the layer of ceramic materials at step S226, coating a layer of lithium-ion conducting material on the layer of polymeric materials at step S228, and/or drying the substrate to obtain the ceramic composite separator at step S229. In various embodiments, the substrate can include a porous polymer or a cellulose substrate, and/or can include one of PET, PO, PE, PP, boron nitride fibers or non-woven cellulose-based materials.

In various embodiments, the substrate has a porosity between 20% and 80%. In various embodiments, the layer of ceramic material has a thickness between 5 microns and 40 microns. In various embodiments, the polymeric material can include one or more of ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI). In various embodiments, the polymeric material can include a plurality of lithium metal particles.

In various embodiments of the method, the lithium-ion conducting material can include one or more material from a list comprising a lithium conducting sulphide, Li₂S, P₂S₅, a lithium phosphate, Li₃P, a lithium oxide, lithium lanthanum titanium oxide, and lithium lanthanum zirconium oxide. In various embodiments, the lithium-ion conducting material can include particles with a particle size ranging between 0.5 microns and 20 microns.

In various embodiments, method S200 can optionally include, at step S225, activating reduction reaction of the substrate. In various embodiments, method S200 can include, at step S225, activating reduction reaction of the substrate, optionally prior to step S226, namely, the coating of the layer of polymeric materials on top of the layer of ceramic materials.

FIG. 3C further illustrates various embodiments of the method S200. In various embodiments, method S200 can optionally include, at step S212, coating a first conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI). In various embodiments, optionally prior to placing the first electrode against the ceramic composite separator at step S220, the method can include the step S212, namely, coating a first conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI). In various embodiments, method S200 can optionally include, at step S213, drying the coated first conductor material to obtain the first electrode.

In various embodiments, method S200 can optionally include, at step S214, coating a second conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI). In various embodiments, optionally prior to placing the second electrode against the ceramic composite separator at step S220, the method can include, at step S214, coating a second conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI). In various embodiments, method S200 can optionally include, at step S215, drying the coated second conductor material to obtain the second electrode.

In various embodiments, the method S200 can optionally include, at step S216, coating the first conductor material and the second conductor material with a plurality of lithium metal particles.

### RECITATION OF EMBODIMENTS

Embodiment 1. A separator for an electrochemical cell comprising a membrane embedded with a ceramic polymer composite.

Embodiment 2. The separator of Embodiment 1, wherein the ceramic polymer composite comprises a microporous crosslinked polymer containing a dissociable lithium salt that functions as an ion-conducting component of the membrane.

Embodiment 3. The separator of Embodiments 1 or 2, wherein the membrane comprises embedded pores within the membrane.

Embodiment 4. The separator of any one of the preceding Embodiments, wherein the ceramic polymer composite is electrically insulating, ionically conducting, and capable of growing solid electrolyte interphase (SEI) within the membrane or within embedded pores of the membrane due to the presence of lithium 2-fluoromethylene-4,5-dicyanoimidazolide anion (LiTDI⁻).

Embodiment 5. The separator of any one of the preceding Embodiments, wherein the membrane comprises one or more of PET, PP, PE, PO, boron nitride or cellulose-based materials.

Embodiment 6. The separator of any one of the preceding Embodiments, wherein the ceramic polymer composite comprises one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 7. The separator of any one of the preceding Embodiments, wherein the membrane comprises an inert ceramic coating of Alumina (Al₂O₃) or Boehmite AlO(OH).

Embodiment 8. The separator of any one of the preceding Embodiments, wherein a porosity of the membrane is between 20% and 80%.

Embodiment 9. The separator of any one of the preceding Embodiments, wherein the membrane has a thickness between 5 microns and 40 microns.

Embodiment 10. The separator of any one of the preceding Embodiments, wherein the membrane comprises a plasticizing organic carbonate liquid containing a dissociable lithium salt.

Embodiment 11. The separator of Embodiment 10, wherein the membrane comprises a composition containing the dissociable lithium salt, the composition being different from the plasticizing organic carbonate liquid.

Embodiment 12. The separator of any one of the preceding Embodiments, wherein the membrane comprises a polycarbonate or a carbonate containing a polymer with a monomer composition corresponding to a composition of carbonate containing liquid from a list of organic carbonates, ethylene carbonate, dimethyl carbonate, ethyl-methyl carbonate, propylene carbonate, fluorinated ethylene carbonate, or a mixture thereof.

Embodiment 13. A solid-state lithium-ion battery comprising the separator of any one of the preceding Embodiments 1-12.

Embodiment 14. A lithium metal rechargeable battery comprising the separator of any one of the preceding Embodiments 1-12.

Embodiment 15. An electrochemical cell comprising: a first electrode; a ceramic composite separator; and a second electrode.

Embodiment 16. The electrochemical cell of Embodiment 15, wherein the ceramic composite separator comprises a membrane embedded with a ceramic polymer composite.

Embodiment 17. The electrochemical cell of Embodiments 15 or 16, wherein the ceramic polymer composite comprises a microporous crosslinked polymer containing a dissociable lithium salt that functions as an ion-conducting component of the membrane.

Embodiment 18. The electrochemical cell of any one of the preceding Embodiments, wherein the ceramic composite separator comprises embedded pores within the membrane.

Embodiment 19. The electrochemical cell of any one of the preceding Embodiments, wherein the ceramic polymer composite is electrically insulating, ionically conducting, and capable of growing solid electrolyte interphase (SEI) within the membrane or within embedded pores of the membrane due to the presence of lithium 2-fluoromethylene-4,5-dicyanoimidazolide anion (LiTDI⁻).

Embodiment 20. The electrochemical cell of any one of the preceding Embodiments, wherein the membrane comprises one or more of PET, PP, PE, PO, boron nitride or cellulose-based materials.

Embodiment 21. The electrochemical cell of any one of the preceding Embodiments, wherein the ceramic polymer composite comprises one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 22. The electrochemical cell of any one of the preceding Embodiments, wherein the membrane comprises an inert ceramic coating of Alumina (Al₂O₃) or Boehmite AIO(OH).

Embodiment 23. The electrochemical cell of any one of the preceding Embodiments, wherein a porosity of the membrane is between 20% and 80%.

Embodiment 24. The electrochemical cell of any one of the preceding Embodiments, wherein the membrane has a thickness between 5 microns and 40 microns.

Embodiment 25. The electrochemical cell of any one of the preceding Embodiments, wherein the membrane comprises a plasticizing organic carbonate liquid containing a dissociable lithium salt.

Embodiment 26. The electrochemical cell of Embodiment 25, wherein the membrane comprises a composition containing the dissociable lithium salt, the composition being different from the plasticizing organic carbonate liquid.

Embodiment 27. The electrochemical cell of any one of the preceding Embodiments, wherein the membrane comprises a polycarbonate or a carbonate containing a polymer with a monomer composition corresponding to a composition of carbonate containing liquid from a list of organic carbonates, ethylene carbonate, dimethyl carbonate, ethyl-methyl carbonate, propylene carbonate, fluorinated ethylene carbonate, or a mixture thereof.

Embodiment 28. The electrochemical cell of any one of the preceding Embodiments, wherein the first electrode comprises a lithium metal, lithium foil, a graphite, a lithiated graphite, LiC₆, a lithium ceramic glass, Li₄Ti₅O₂, Li_{4,4}Si, or lithium metal alloys LiM (M=Si, Sn, Zn, In, Ge) bound together with polyvinylidene fluoride (PVDF).

Embodiment 29. The electrochemical cell of any one of the preceding Embodiments, wherein the first electrode comprises a coating having one or more materials from a list of organic carbonates, ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI), lithium bis(trifluoromethanesulfonyl)imide (LiTFSI) or lithium bis(fluorosulfonyl)imido (LiFSI).

Embodiment 30. The electrochemical cell of any one of the preceding Embodiments, wherein the first electrode comprises a plurality of lithium metal particles.

Embodiment 31. The electrochemical cell of any one of the preceding Embodiments, wherein the second electrode comprises a lithiated metal oxide, LiCoO₂, LiFePO₄, LiMn₂O₄, LiNiO₂, Li₂FePO₄F, Li(LiₐNiₓMn_{y}Co_{z}) (NMC), or Li(LiₐNiₓAl_{y}Co_{z}) (NCA), a conductive carbon additive, carbon fiber, carbon black, acetylene black bound together with PVDF.

Embodiment 32. The electrochemical cell of any one of the preceding Embodiments, wherein the second electrode comprises a coating having one or more materials from a list of organic carbonates, ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI).

Embodiment 33. The electrochemical cell of any one of the preceding Embodiments, wherein the second electrode comprises a plurality of lithium metal particles.

Embodiment 34. The electrochemical cell of any one of the preceding Embodiments, wherein the ceramic composite separator comprises self-healing properties as a result of a specific mixture of a dissociable lithium salt, a carbonate solvent mixture, and lithium metal surface.

Embodiment 35. The electrochemical cell of Embodiment 35, wherein the ceramic composite separator prevents dendrite growth due to its self-healing properties.

Embodiment 36. The electrochemical cell of Embodiments 35 or 36, wherein the ceramic composite separator resists fracture and cracking as a result of vibrational and shock forces typically seen in battery use in electric vehicles.

Embodiment 37. A method of preparing a separator for an electrochemical cell, comprising: providing a base membrane; coating a layer of ceramic material on the base membrane; coating a layer of polymeric material on top of the layer of ceramic materials; coating a layer of lithium-ion conducting material on the layer of polymeric materials; and drying the coated membrane to obtain the separator.

Embodiment 38. The method of Embodiment 37, wherein the base membrane comprises a porous polymer or a cellulose substrate.

Embodiment 39. The method of Embodiments 37 or 38, wherein the base membrane comprises one of PET, PO, PE, PP, boron nitride fibers or non-woven cellulose-based materials.

Embodiment 40. The method of any one of the preceding Embodiments, wherein the base membrane has a porosity between 20% and 80%.

Embodiment 41. The method of any one of the preceding Embodiments, wherein the layer of ceramic material has a thickness between 5 microns and 40 microns.

Embodiment 42. The method of any one of the preceding Embodiments, wherein the polymeric material comprises one or more of ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI).

Embodiment 43. The method of any one of the preceding Embodiments, wherein the polymeric material comprises a plurality of lithium metal particles.

Embodiment 44. The method of any one of the preceding Embodiments, wherein the lithium-ion conducting material comprises one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 45. The method of any one of the preceding Embodiments, wherein the lithium-ion conducting material comprise particles with a particle size ranging between 0.5 microns and 20 microns.

Embodiment 46. A method of preparing an electrochemical cell, comprising: preparing a ceramic composite separator; and placing a first electrode and a second electrode against the ceramic composite separator, thereby forming the electrochemical cell, wherein, during operation, the ceramic composite separator is capable of growing a passivating polymer layer at an interface between the first electrode and the second electrode.

Embodiment 47. The method of Embodiment 46, wherein the preparing the ceramic composite separator further comprises: providing a substrate; coating a layer of ceramic material on the substrate; coating a layer of polymeric material on top of the layer of ceramic materials; coating a layer of lithium-ion conducting material on the layer of polymeric materials; and drying the substrate to obtain the ceramic composite separator.

Embodiment 48. The method of Embodiment 47, wherein the substrate comprises a porous polymer or a cellulose substrate.

Embodiment 49. The method of any one of the preceding Embodiments, wherein the substrate comprises one of PET, PO, PE, PP, boron nitride fibers or non-woven cellulose-based materials.

Embodiment 50. The method of any one of the preceding Embodiments, wherein the substrate has a porosity between 20% and 80%.

Embodiment 51. The method of any one of the preceding Embodiments, wherein the layer of ceramic material has a thickness between 5 microns and 40 microns.

Embodiment 52. The method of any one of the preceding Embodiments, wherein the polymeric material comprises one or more of ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI).

Embodiment 53. The method of any one of the preceding Embodiments, wherein the polymeric material comprises a plurality of lithium metal particles.

Embodiment 54. The method of any one of the preceding Embodiments, wherein the lithium-ion conducting material comprises one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 55. The method of any one of the preceding Embodiments, wherein the lithium-ion conducting material comprise particles with a particle size ranging between 0.5 microns and 20 microns.

Embodiment 56. The method of any one of the preceding Embodiments, prior to the coating of the layer of polymeric materials on top of the layer of ceramic materials, the method further comprising: activating reduction reaction of the substrate.

Embodiment 57. The method of any one of the preceding Embodiments, wherein prior to placing the first electrode against the ceramic composite separator, the method further comprising: coating a first conductor material with one or more materials from a list of organic carbonates, ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI); and drying the coated first conductor material to obtain the first electrode.

Embodiment 58. The method of Embodiment 57, prior to placing the second electrode against the ceramic composite separator, the method further comprising: coating a second conductor material with one or more materials from a list of organic carbonates, ethylene carbonate, dimethyl carbonate, ethyl-methyl carbonate, propylene carbonate, fluorinated ethylene carbonate, or some mixture thereof) containing lithium 2-Trifluoromethyl-4,5-dicyanoimidazolide (LiTDI); and drying the coated second conductor material to obtain the second electrode.

Embodiment 59. The method Embodiment 58, further comprising: coating the first conductor material and the second conductor material with a plurality of lithium metal particles.

Embodiment 60. A separator for an electrochemical cell comprising a membrane embedded with a ceramic polymer composite, wherein the ceramic polymer composite comprises a microporous crosslinked polymer containing a dissociable lithium salt that functions as an ion-conducting component of the membrane.

Embodiment 61. The separator of Embodiment 60, wherein the membrane comprises embedded pores within the membrane, and/or wherein a porosity of the membrane is between 20% and 80%, or wherein the membrane has a thickness between 5 microns and 40 microns.

Embodiment 62. The separator of Embodiments 60 or 61, wherein the ceramic polymer composite is electrically insulating, ionically conducting, and capable of growing solid electrolyte interphase (SEI) within the membrane or within embedded pores of the membrane.

Embodiment 63. The separator of any of Embodiments 60-62, wherein the ceramic polymer composite comprises one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

Embodiment 64. The separator of any of Embodiments 60-63, wherein the membrane comprises one or more of PET, PP, PE, PO, boron nitride or cellulose-based materials.

Embodiment 65. The separator of any of Embodiments 60-64, wherein the membrane comprises an inert ceramic coating of Alumina (Al₂O₃) or Boehmite AIO(OH), or a plasticizing organic carbonate liquid containing a dissociable lithium salt.

Embodiment 66. The separator of any of Embodiments 60-65, wherein the membrane comprises a composition containing the dissociable lithium salt, the composition being different from the plasticizing organic carbonate liquid.

Embodiment 67. The separator of any of Embodiments 60-66, wherein the membrane comprises a polycarbonate or a carbonate containing a polymer with a monomer composition corresponding to a composition of carbonate containing liquid from a list of organic carbonates, ethylene carbonate, dimethyl carbonate, ethyl-methyl carbonate, propylene carbonate, fluorinated ethylene carbonate, or a mixture thereof.

Embodiment 68. An electrochemical cell comprising the separator of any of Embodiments 60-67.

Embodiment 69. A method of preparing a separator for an electrochemical cell, comprising: providing a base membrane; coating a layer of ceramic material on the base membrane; coating a layer of polymeric material on top of the layer of ceramic materials; coating a layer of lithium-ion conducting material on the layer of polymeric materials; and drying the coated membrane to obtain the separator.

Embodiment 70. The method of Embodiment 69, wherein the base membrane comprises a porous polymer or a cellulose substrate, or wherein the base membrane comprises one of PET, PO, PE, PP, boron nitride fibers or non-woven cellulose-based materials.

Embodiment 71. The method of Embodiments 69 or 70, wherein the base membrane has a porosity between 20% and 80%, or wherein the layer of ceramic material has a thickness between 5 microns and 40 microns.

Embodiment 72. The method of any of Embodiments 69-71, wherein the polymeric material comprises one or more of ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI).

Embodiment 73. The method of any of Embodiments 69-72, wherein the polymeric material comprises a plurality of lithium metal particles.

Embodiment 74. A method of preparing an electrochemical cell, comprising: preparing a ceramic composite separator; and placing a first electrode and a second electrode against the ceramic composite separator, thereby forming the electrochemical cell, wherein, during operation, the ceramic composite separator is capable of growing a passivating polymer layer at an interface between the first electrode and the second electrode.

Embodiment 75. The method of Embodiment 74, wherein the preparing the ceramic composite separator further comprises: providing a substrate; coating a layer of ceramic material on the substrate; coating a layer of polymeric material on top of the layer of ceramic materials; coating a layer of lithium-ion conducting material on the layer of polymeric materials; and drying the substrate to obtain the ceramic composite separator.

Embodiment 76. The method of Embodiment 75, prior to the coating of the layer of polymeric materials on top of the layer of ceramic materials, the method further comprising: activating reduction reaction of the substrate.

Embodiment 77. The method of any of Embodiments 74-76, prior to placing the first electrode against the ceramic composite separator, the method further comprising: coating a first conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI); and drying the coated first conductor material to obtain the first electrode.

Embodiment 78. The method of any of Embodiments 74-77, prior to placing the second electrode against the ceramic composite separator, the method further comprising: coating a second conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI); and drying the coated second conductor material to obtain the second electrode.

Embodiment 79. The method of any of Embodiments 74-78, further comprising: coating the first conductor material and the second conductor material with a plurality of lithium metal particles.

1. A separator for an electrochemical cell comprising a membrane embedded with a ceramic polymer composite, wherein the ceramic polymer composite comprises a microporous crosslinked polymer containing a dissociable lithium salt that functions as an ion-conducting component of the membrane.

2. The separator of claim 1, wherein the membrane comprises embedded pores within the membrane, and/or wherein a porosity of the membrane is between 20% and 80%, or wherein the membrane has a thickness between 5 microns and 40 microns.

3. The separator of claim 1, wherein the ceramic polymer composite is electrically insulating, ionically conducting, and capable of growing solid electrolyte interphase (SEI) within the membrane or within embedded pores of the membrane.

4. The separator of claim 1, wherein the ceramic polymer composite comprises one or more material from a list comprising a lithium conducting sulphide, Li₂S, P₂S₅, a lithium phosphate, Li₃P, a lithium oxide, lithium lanthanum titanium oxide, and lithium lanthanum zirconium oxide.

5. The separator of claim 1, wherein the membrane comprises one or more of PET, PP, PE, PO, boron nitride or cellulose-based materials.

6. The separator of claim 1, wherein the membrane comprises an inert ceramic coating of Alumina (Al₂O₃) or Boehmite AlO(OH), or a plasticizing organic carbonate liquid containing a dissociable lithium salt.

7. The separator of claim 1, wherein the membrane comprises a composition containing the dissociable lithium salt, the composition being different from the plasticizing organic carbonate liquid.

8. The separator of claim 1, wherein the membrane comprises a polycarbonate or a carbonate containing a polymer with a monomer composition corresponding to a composition of carbonate containing liquid from a list of organic carbonates, ethylene carbonate, dimethyl carbonate, ethyl-methyl carbonate, propylene carbonate, fluorinated ethylene carbonate, or a mixture thereof.

9. An electrochemical cell comprising the separator of claim 1.

10. A method of preparing a separator for an electrochemical cell, comprising:
providing a base membrane;
coating a layer of ceramic material on the base membrane;
coating a layer of polymeric material on top of the layer of ceramic materials;
coating a layer of lithium-ion conducting material on the layer of polymeric materials; and
drying the coated membrane to obtain the separator.

11. The method of claim 10, wherein the base membrane comprises a porous polymer or a cellulose substrate, or wherein the base membrane comprises one of PET, PO, PE, PP, boron nitride fibers or non-woven cellulose-based materials.

12. The method of claim 10, wherein the base membrane has a porosity between 20% and 80%, or wherein the layer of ceramic material has a thickness between 5 microns and 40 microns.

13. The method of claim 10, wherein the polymeric material comprises one or more of ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI).

14. The method of claim 10, wherein the polymeric material comprises a plurality of lithium metal particles.

15. A method of preparing an electrochemical cell, comprising:
preparing a ceramic composite separator; and
placing a first electrode and a second electrode against the ceramic composite separator, thereby forming the electrochemical cell, wherein, during operation, the ceramic composite separator is capable of growing a passivating polymer layer at an interface between the first electrode and the second electrode.

16. The method of claim 15, wherein the preparing the ceramic composite separator further comprises:
providing a substrate;
coating a layer of ceramic material on the substrate;
coating a layer of polymeric material on top of the layer of ceramic materials;
coating a layer of lithium-ion conducting material on the layer of polymeric materials; and
drying the substrate to obtain the ceramic composite separator.

17. The method of claim 16, prior to the coating of the layer of polymeric materials on top of the layer of ceramic materials, the method further comprising:
activating reduction reaction of the substrate.

18. The method of claim 15, prior to placing the first electrode against the ceramic composite separator, the method further comprising:
coating a first conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI); and
drying the coated first conductor material to obtain the first electrode.

19. The method of claim 18, prior to placing the second electrode against the ceramic composite separator, the method further comprising:
coating a second conductor material with one or more materials from a list of organic carbonates, ethylene carbonate, dimethyl carbonate, ethyl-methyl carbonate, propylene carbonate, fluorinated ethylene carbonate, or some mixture thereof containing lithium 2-Trifluoromethyl-4,5-dicyanoimidazolide (LiTDI), and
drying the coated second conductor material to obtain the second electrode.

20. The method of claim 19, further comprising:
coating the first conductor material and the second conductor material with a plurality of lithium metal particles.
